(19) United States
(12) Patent Application Publication
(10) Pub. No.: US 2006/0140729 A1
(43) Pub. Date: Jun. 29, 2006

(54) Tool holder and method of placing the insert

(76) Inventor: Toan Dat Tran, Houston, TX (US)

Correspondence Address: Toan Dat TRAN, 10300 HARWIN DR. # 710, Houston, TX, 77036, US

(21) Appl. No.: 11/020,823

(22) Filed: Dec. 27, 2004

(51) Int. Cl. B23C 5/00

(52) U.S. Cl. 407/33; 407/66

(57) ABSTRACT

The outer diameter roughing in a CNC lathe turning process utilizes generally inserts with zero degree negative clearance angle (N−0 degree Negative) for economic purposes. The common roughing tool holder is using the diamond shape insert, the so called CN_or DN_insert. In a variation of these conventional tool holders only one corner (mostly 80/55 degree) of the insert is in cutting operation. The other corner (110/125 degree) could be reused in another tool holder.

### SUMMARY OF THE INVENTION

It is therefore an object of this invention to provide a new form of tool holder specially for heavy turning in lathe which is capable of using all the both cutting corners and edges of the insert. The tool life of the insert in operation will be longer.

The instant invention is a tool holder with standard sized shank: shank length L and height H etc. . . .

The instant invention is a tool holder in which the two corners of a diamond shape insert can cut in facing and deep roughing along the Z-axis of an CNC machine.

Most notably, the instant invention provides the method of placing the diamond shape insert DN_or CN_(eventually CP_) in 3D space in reference to the holder shank. The instant invention provides method for set up the tool in an CNC lathe machine With 2 different and related tool off-sets.

These and other advantages of the invention will appear fully in the following description And explanation.

### A BRIEF DESCRIPTION OF THE DRAWINGS

FIG. 1 shows a top view of a DN-insert in 15 degrees side cutting edge angle.

FIG. 2 shows the relief angle measurement of the cutting edge AD.

FIG. 3 shows the tool path in facing and roughing with the so placed DN-insert.

FIG. 4 shows the tool holder with the DN_insert from FIG. 1 and insert seat in top view.

FIG. 5 shows the left side view of the same tool holder.

FIG. 6 shows the tool holder in isometric view.

FIG. 7 shows a top view of a CN_insert in 20 degrees side cutting edge angle.

FIG. 8 shows the top view of a CP_insert at 20 degrees lead angle.

### DESCRIPTION OF THE PREFERRED EMBODIMENTS OF THE INVENTION

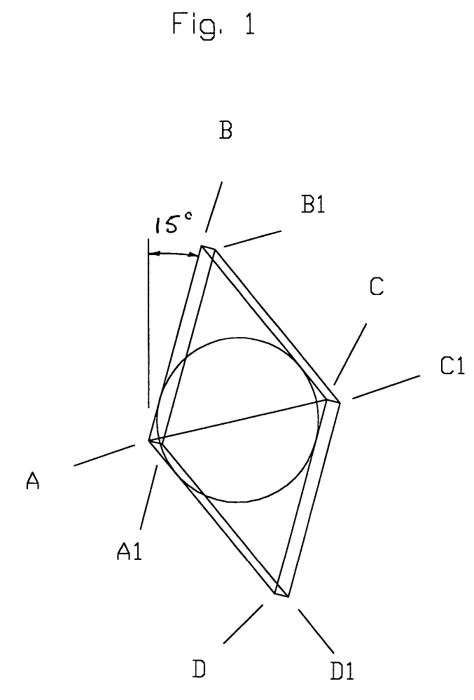

According to FIG. 1, an 55 degree DN_insert has been designed with intentionally an I.C on the top of the insert for clear distinction from the bottom. All the 8 corners are Sharp corners without any fillet for more clarity of the view.

First the insert diamond shape has been drawn on the screen of a CAD computer, the OXY plan and then extruded negatively to its standard depth/thickness, for instance

I.C=0.5, thickness=0.1875 (0.25 for heavy duties)

A, B, C and D are the upper corners of the insert top.

A1, B1, C1 and D1 are the lower corners of the insert bottom.

Similar to a tool holder style B with 15 degree side cutting edge angle the DN_insert is therefore placed 15 degree in reference to Vertical with the 55 degree corner at the top of the tool length. The insert is then rotated about AB axis by minus 14 degrees. After this 3D rotations the corners A and B are still unchanged in the OXY plan. A DN_insert with 20 degree positive sharp chipbreaker, for instance DNMP-432-FF from Kennametal USA, is helpful to reduce this negative rake angle to plus 6 degrees effective. B1 is behind B and is lower than B. BC is not a cutting edge. A1 is behind A and is located inside the top shape (from top view). AB is the primary cutting edge with 14 degrees relief angle beneath. B1 will not touch the material by roughing. AD is a secondary cutting edge with an optimal relief angle for cutting without pushing the material.

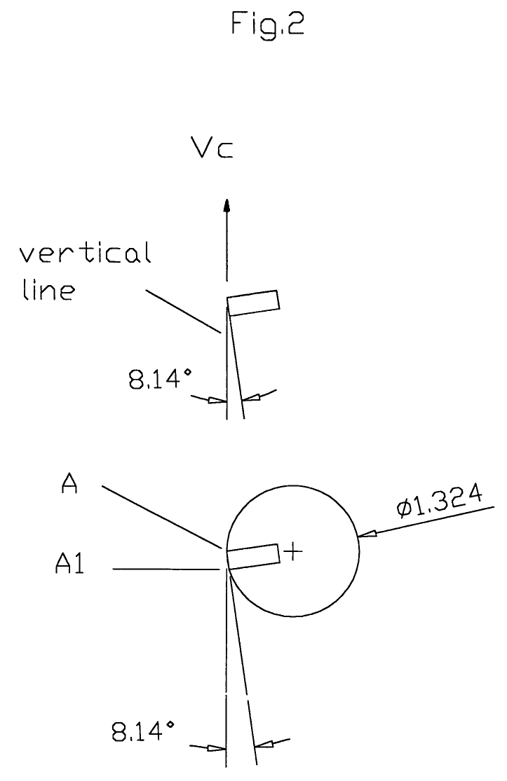

FIG. 2 shows Vc the cutting force. By adding a vertical line to A in negative Z direction and after placing the coordinate system in A with AD as Z positive direction, the AD relief angle appears on the top view: 8.14 degrees. This insert when placed in a tool holder will have 2 cutting corners A and B at the same level which go both through the center line of the spindle of an CNC lathe. Today' inserts has positive standard chipbreakers along the whole cutting edges without interruption. For facing/roughing it is preferable to choose a DN_insert with 13 degree positive sharp chipbreaker, for example the DNMG-432-EPX from Doriantool TX or the DNMG-433-TF from Iscar, to change the negative cutting rake angle from −14 to −1 degree and from −8.14 to +4.86 degrees effective.

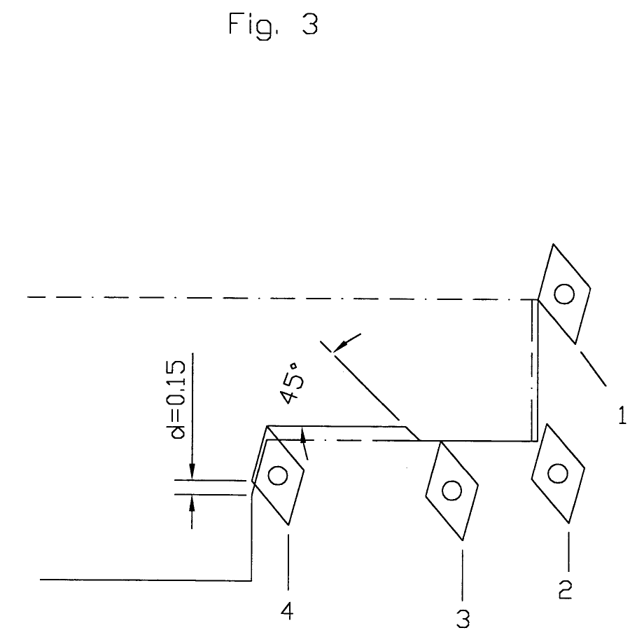

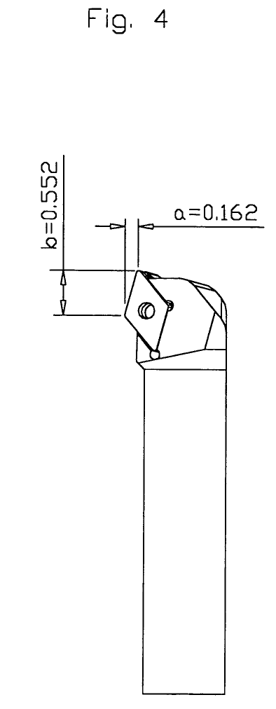

FIG. 3 shows some positions of the so placed DN_insert in turning operations. The inserts (1) and (2) are doing the facing with the bigger corner A (125 degrees) in standard steps (0.05-0.07). The inserts (3) and (4) are doing deep roughing with The smaller corner B (55 degree). When the insert (4) reaches the end position in Z-axis, It will used a small portion of its AD cutting edge while retracting in X-axis to cut the remaining of material. The retracting distance d is equal to the cutting depth. In position (4) as shown in FIG. 2, the bottom corner A1 begins to interfere with the material at a certain outer diameter of the work piece 1.324-2b=0.22 Inch. b is the specific tool off set in Z-direction (FIG. 4). It is also to notice that in rapid move the insert (2) has to go a little deeper (after FIG. 3 here) for the 2^{nd} pass to avoid collision while approaching the work piece.

FIG. 4 reveals 2 specific tool off-sets in X and Z direction of a CNC lathe. The so placed insert has geometry off-sets: a in Z-direction and b in X-direction.
T0101 is for facing//T0121 is for roughing

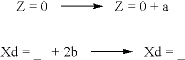

After the 1^{st} manual facing, T0101 is set to Z=0. The T0121 will be set to a.

After the 1^{st} manual rough, T0121 is set to Xd, the diameter of the work piece, T0101 Will be set to Xd+2b.

This tool holder has therefore a minimum outer diameter O.D=0.22 inches as limit before collision.

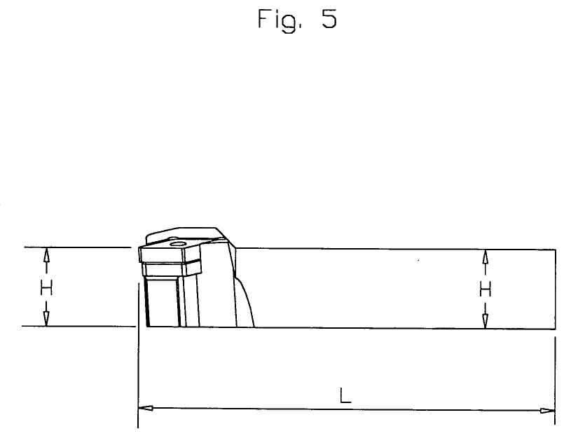

FIG. 5 shows the side view of the tool holder with the so placed DN_insert. The primary cutting edge AB is appearing horizontally and at the same height H from the holder bottom.

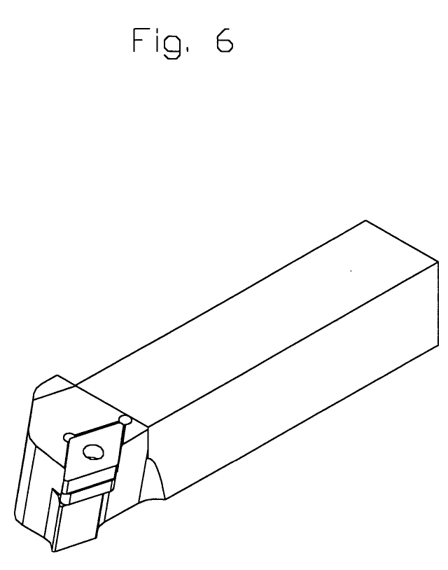

FIG. 6 is the isometric view of the tool holder without clamping screw for more clarity.

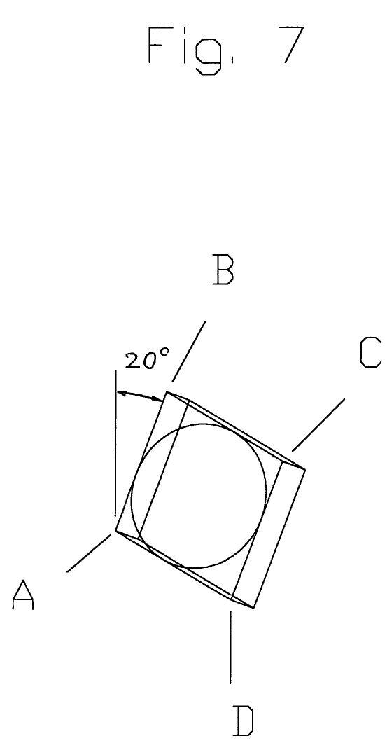

FIG. 7 To turn work pieces with big diameters over 1.4 inches the tool holder can use also a CN_insert by rotating it about the edge AB by minus 26 degree to get a certain relief angle 4.84 degree for the secondary cutting edge AD. The lead angle here is 20 degrees. The effective cutting rake angle by using the CNMG-432-FF insert from Kennametal USA with sharp 20 degrees positive chipbreaker is minus 6 degrees for the primary cutting edge AB and plus 15.16 degree for the cutting edge AD.

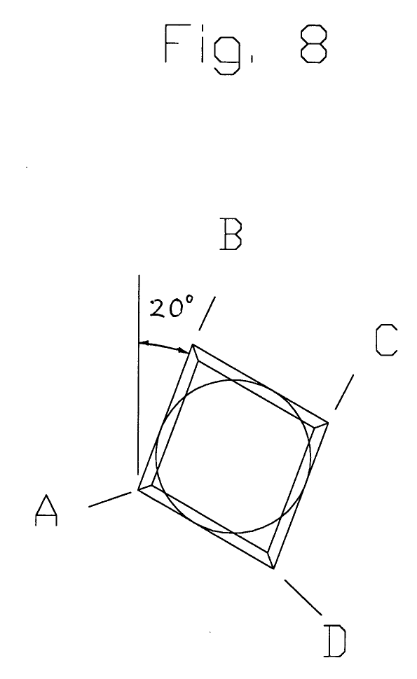

FIG. 8 shows a CPMT-432 ENS insert from Sumitomo with 11 degrees relief angle placed at 20 degrees lead angle and by 0 degree rake angle for the edge AB. The tool holder using this so placed insert can rough to center line of the spindle without collision.

As described above, the tool holder of the present invention is utilizing essentially the N-0 degree negative clearance angle diamond shape insert to face and rough with 2 different cutting corners of the same cutting edge AB. It is the intention to include all such embodiments and modifications within the scope of the invention as defined by the appended claims.

What is claimed is:

1. A tool holder comprising a square shape or alike shank for machining outer diameter of a work piece in a lathe operation is using two cutting corners (A and B in FIG. 1) of a N-zero degree negative clearance angle diamond shape insert for facing and deep roughing, and has two related tool off-sets for a CNC-lathe control.

2. A tool holder after claim 1 in which the insert is so located that its two cutting corners are at the same height H from the shank bottom, in negative rake angles and has 15 degrees or more/less side cutting edge angles.

3. A tool holder after claim 1 the insert can be a CP_insert with positive clearance angle.
